(19) United States
(12) Patent Application Publication
(10) Pub. No.: US 2011/0235569 A1
(43) Pub. Date: Sep. 29, 2011

(54) RADIO BEARER MANAGEMENT AT A DONOR BASE STATION IN A WIRELESS NETWORK WITH RELAYS

(75) Inventors: XIAOLONG HUANG, San Diego, CA (US); FATIH ULUPINAR, San Diego, CA (US)

(73) Assignee: QUALCOMM Incorporated, San Diego, CA (US)

(21) Appl. No.: 13/071,250

(22) Filed: Mar. 24, 2011

Related U.S. Application Data
(60) Provisional application No. 61/317,932, filed on Mar. 26, 2010.

(51) Int. Cl. H04B 7/14

(52) U.S. Cl. 370/315

(57) ABSTRACT

Certain aspects of the present disclosure provide techniques and apparatuses for managing radio bearers during traffic congestion in a wireless communications networks having relays. According to certain aspects, a donor base station may detect traffic congestion on a Un radio bearer configured to interface between the relay node and the donor base station, where the Un radio bearer carries a plurality of Uu bears configured to interface between the relay node and at least one user equipment (UE). According to certain aspects, the donor base station may take one or more actions to trigger removal of at least one of the Uu bearers carried on the Un bearer.

### CLAIM OF PRIORITY UNDER 35 U.S.C. §119

The present application for patent claims benefit of U.S. Provisional Patent Application Ser. No. 61/317,932, entitled, “Method and Apparatus that Facilitates Bearer Management at an Evolved Node B For Long Term Evolution Systems with Relays,” filed Mar. 25, 2010 and assigned to the assignee hereof and hereby expressly incorporated by reference herein.

### BACKGROUND

1. Field

Certain aspects of the disclosure relate generally to wireless communications systems and, more particularly, to techniques for managing radio bearers in telecommunication networks with relays.

2. Background

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-signal-out or a multiple-in-multiple-out (MIMO) system.

A MIMO system employs multiple (NT) transmit antennas and multiple (NR) receive antennas for data transmission. A MIMO channel formed by the NT transmit and NR receive antennas may be decomposed into NS independent channels, which are also referred to as spatial channels, where N_{S}≦min{N_{T}, N_{R}}. Each of the NS independent channels corresponds to a dimension. The MIMO system can provide improved performance (e.g., higher throughput and/or greater reliability) if the additional dimensionalities created by the multiple transmit and receive antennas are utilized.

A MIMO system supports a time division duplex (TDD) and frequency division duplex (FDD) systems. In a TDD system, the forward and reverse link transmissions are on the same frequency region so that the reciprocity principle allows the estimation of the forward link channel from the reverse link channel. This enables the access point to extract transmit beamforming gain on the forward link when multiple antennas are available at the access point.

Wireless communication systems may comprise a donor base station that communicates with wireless terminals via a relay base station. The relay base station may communicate with the donor base station via a backhaul link and with the terminals via an access link. In other words, the relay base station may receive downlink messages from the donor base station over the backhaul link and relay these messages to the terminals over the access link. Similarly, the relay base station may receive uplink messages from the terminals over the access link and relay these messages to the donor base station over the backhaul link. The relay base station may, thus, be used to supplement a coverage area and help fill “coverage holes.”

Generally, a bearer is defined as a packet flow with a defined Quality of Service (QoS) between a gateway and a user equipment (UE). In telecommunication networks with relay nodes, bearers employed for packet flows between a relay node and its served UEs (referred to as “Uu bearers”) are carried by data radio bearers (DRBs) employed for relay packet flows between the relay node and a donor base station (DeNB) associated therewith (referred to as “Un data radio bearers”). In some cases, when the condition of the backhaul link between the relay node and DeNB deteriorates, or where too many Uu bearers have been admitted over the backhaul link, the DeNB may experience congestion on its Un interface that serves the backhaul. Meanwhile, the Uu interface between the relay node and the relay's served UEs observes no capacity problem. As such, there is a demand for techniques and mechanisms for managing radio bearers carried by a donor base station and relay node in a wireless network.

### SUMMARY

Certain aspects of the present disclosure provide a method for operating a donor base station having a first plurality of radio bearers (RBs) that interface with a relay node. The method generally includes determining traffic congestion on the first plurality of RBs, and taking one or more actions to trigger removal of at least one of a second plurality of RBs that interface between the relay node and at least one user equipment (UE).

Certain aspects of the disclosure also provide a donor base station having a first plurality of radio bearers (RBs) that interface with a relay node. The donor base station generally includes a traffic monitor component configured to determine traffic congestion on the first plurality of RBs. The donor base station further includes a radio bearer manager component configured to take one or more actions to trigger removal of at least one of a second plurality of RBs that interface between the relay node and at least one user equipment (UE).

Certain aspects of the present disclosure provide an apparatus for wireless communications having a first plurality of radio bearers (RBs) that interface with a relay node. The apparatus generally includes means for determining traffic congestion on the first plurality of RBs, and means for taking one or more actions to trigger removal of at least one of a second plurality of RBs that interface between the relay node and at least one user equipment (UE).

Certain aspects of the present disclosure provide a computer program product comprising a computer readable medium having instructions for operating a donor base station having a first plurality of radio bearers (RBs) that interface with a relay node stored thereon. The instructions are generally executable by one or more processors for determining traffic congestion on the first plurality of RBs, and taking one or more actions to trigger removal of at least one of a second plurality of RBs that interface between the relay node and at least one user equipment (UE).

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a multiple access wireless communication system.

FIG. 2 is a block diagram of a communication system.

FIG. 3 illustrates an exemplary wireless communication system with a relay base station according to certain aspects of the present disclosure.

FIG. 4 is a block diagram of a wireless communication system with a relay node according to certain aspects of the disclosure.

FIG. 5 illustrates exemplary communication apparatuses that manage radio bearers according to certain aspects of the subject disclosure.

FIG. 6 illustrates an example of mapping between radio bearers in a wireless communication system according to certain aspects of the disclosure.

FIG. 7 illustrates example operations that may be performed by a communications apparatus according to certain aspects of the present disclosure.

FIG. 8 is a sequence diagram illustrating example operations for indirect Uu bearer deactivation mechanism according to certain aspects of the disclosure.

FIG. 9 is a sequence diagram illustrating example operations for direct Uu bearer deactivation mechanism according to certain aspects of the disclosure.

FIG. 10 is a sequence diagram illustrating example operations for user equipment context release mechanism according to certain aspects of the disclosure.

### DETAILED DESCRIPTION

Certain aspects of the present disclosure provide apparatuses and techniques for managing radio bearers in a wireless communications network having a relay node and donor base station. In some networks, such as an LTE network having relay nodes, a relay node may serve multiple UE packet flows. The Uu radio bearers used for UE packet flows between the relay node and its served UEs are carried by the Un data radio bearers used for relay packet flows between the relay and its donor base station.

As described above, when the backhaul link condition between the relay node and the donor base station deteriorates, or there are too many UE flows admitted over the backhaul link, the donor base station may experience congestion on its Un interface. When this occurs, it is desirable for the donor base station to release some Uu bearers or UE contexts for UEs that are served under the relay node. However, although the donor base station has visibility of Uu bearers under an LTE relay architecture, the donor base station does not directly administer control plane transactions of the Uu interface. Accordingly, this presents a challenge for relay nodes and donor base stations to efficiently manage wireless resources to provide UE flows over Un radio bearers while maintaining a certain quality of service throughout the communication network.

According to certain aspects, mechanisms for LTE relay networks are provided for a donor base station to remove Uu bearers carried by the donor base station's Un bearers when Un bearers are congested. Certain aspects of the present disclosure generally provide mechanisms to invoke an indirect release of Uu bearers, a direct release of Uu bearers, or a UE context release for a given UE. It is noted that a Uu bearer refers to a radio bearer of an interface between a relay node and user equipment (UE), and may be also be referred to as a Uu radio bearer, or Uu data radio bearer. Also, a Un bearer generally refers to a bearer of an interface between a relay node and an associated donor base station, and may also be referred to as a Un radio bearer, or a Un data radio bearer.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), cdma2000, etc. UTRA includes Wideband-CDMA (W-CDMA) and Low Chip Rate (LCR). cdma2000 covers IS-2000, IS-95 and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a release of UMTS that uses E-UTRA. UTRA, E-UTRA, GSM, UMTS and LTE are described in documents from an organization named “3rd Generation Partnership Project” (3GPP). cdma2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below.

Single carrier frequency division multiple access (SC-FDMA), which utilizes single carrier modulation and frequency domain equalization is a technique. SC-FDMA has similar performance and essentially the same overall complexity as those of OFDMA system. SC-FDMA signal has lower peak-to-average power ratio (PAPR) because of its inherent single carrier structure. SC-FDMA has drawn great attention, especially in the uplink communications where lower PAPR greatly benefits the mobile terminal in terms of transmit power efficiency. It is currently a working assumption for uplink multiple access scheme in 3GPP Long Term Evolution (LTE), or Evolved UTRA.

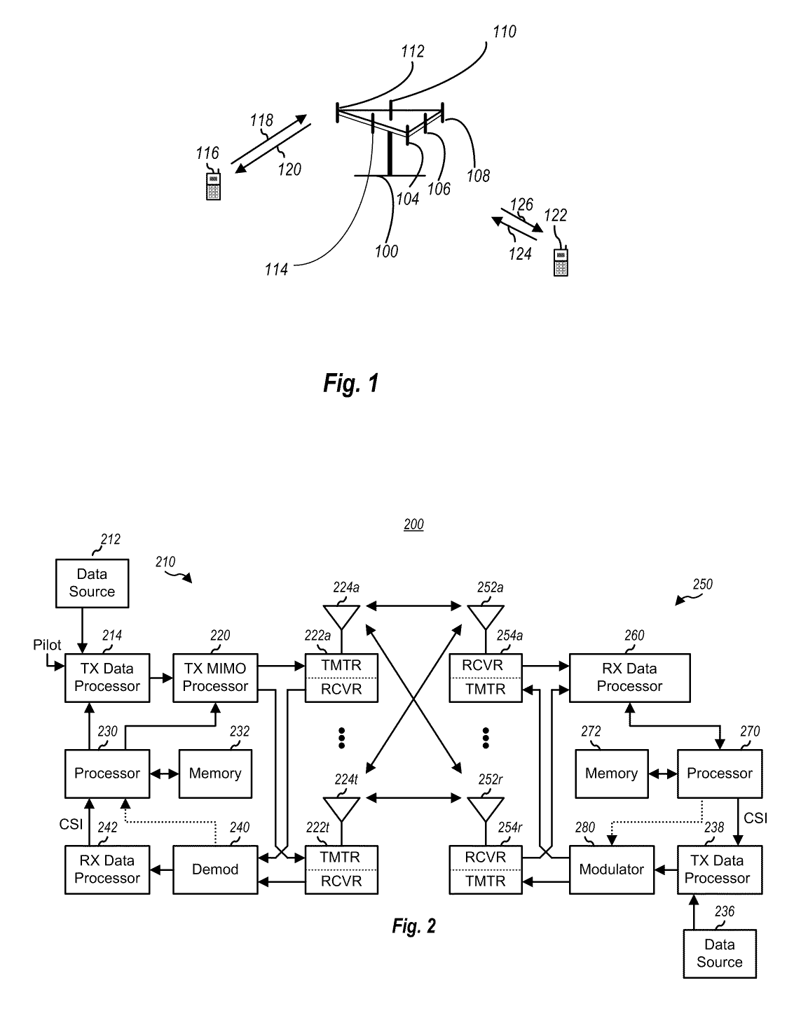

Referring to FIG. 1, a multiple access wireless communication system according to one embodiment is illustrated. An access point 100 (AP) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. Access terminal 122 is in communication with antennas 106 and 108, where antennas 106 and 108 transmit information to access terminal 122 over forward link 126 and receive information from access terminal 122 over reverse link 124. In a FDD system, communication links 118, 120, 124 and 126 may use different frequency for communication. For example, forward link 120 may use a different frequency then that used by reverse link 118.

Each group of antennas and/or the area in which they are designed to communicate is often referred to as a sector of the access point. In the embodiment, antenna groups each are designed to communicate to access terminals in a sector, of the areas covered by access point 100.

In communication over forward links 120 and 126, the transmitting antennas of access point 100 utilize beamforming in order to improve the signal-to-noise ratio of forward links for the different access terminals 116 and 124. Also, an access point using beamforming to transmit to access terminals scattered randomly through its coverage causes less interference to access terminals in neighboring cells than an access point transmitting through a single antenna to all its access terminals.

According to certain aspects, an AT 116 may be in communication with an AP 100 by means of a radio interface having a Uu radio bearer. Further, additional APs 100 may be inter-connected with each other by means of an interface known as X2, and to a network node, such as an Enhanced Packet Core (EPC) node, by means of an S1 interface.

An access point may be a fixed station used for communicating with the terminals and may also be referred to as an access point, a Node B, an evolved Node B (eNB), an eNodeB, or some other terminology. An access terminal may also be called an access terminal, user equipment (UE), a wireless communication device, wireless terminal, access terminal, or some other terminology.

FIG. 2 is a block diagram of an embodiment of a transmitter system 210 (also known as the access point) and a receiver system 250 (also known as access terminal) in a MIMO system 200. At the transmitter system 210, traffic data for a number of data streams is provided from a data source 212 to a transmit (TX) data processor 214.

In an embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (i.e., symbol mapped) based on a particular modulation scheme (e.g., BPSK, QSPK, M-PSK, or M-QAM) selected for that data stream to provide modulation symbols. The data rate, coding, and modulation for each data stream may be determined by instructions performed by processor 230.

The modulation symbols for all data streams are then provided to a TX MIMO processor 220, which may further process the modulation symbols (e.g., for OFDM). TX MIMO processor 220 then provides NT modulation symbol streams to NT transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. NT modulated signals from transmitters 222a through 222t are then transmitted from NT antennas 224a through 224t, respectively.

At receiver system 250, the transmitted modulated signals are received by NR antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the NR received symbol streams from NR receivers 254 based on a particular receiver processing technique to provide NT “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

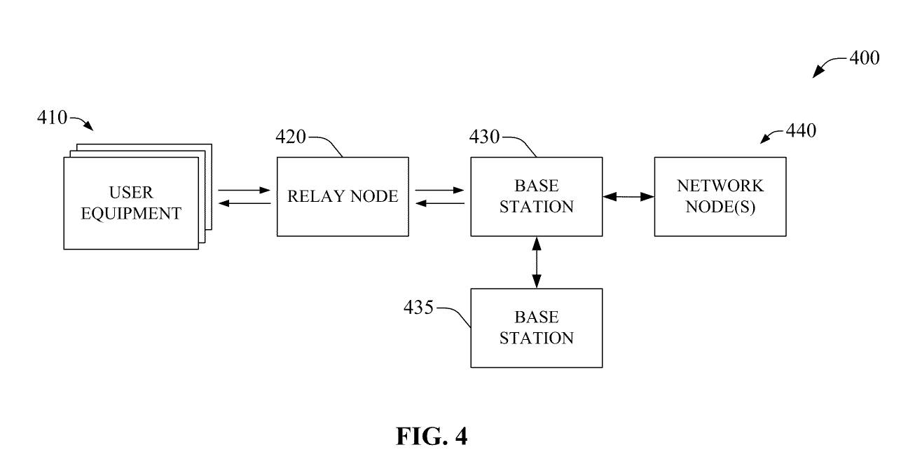

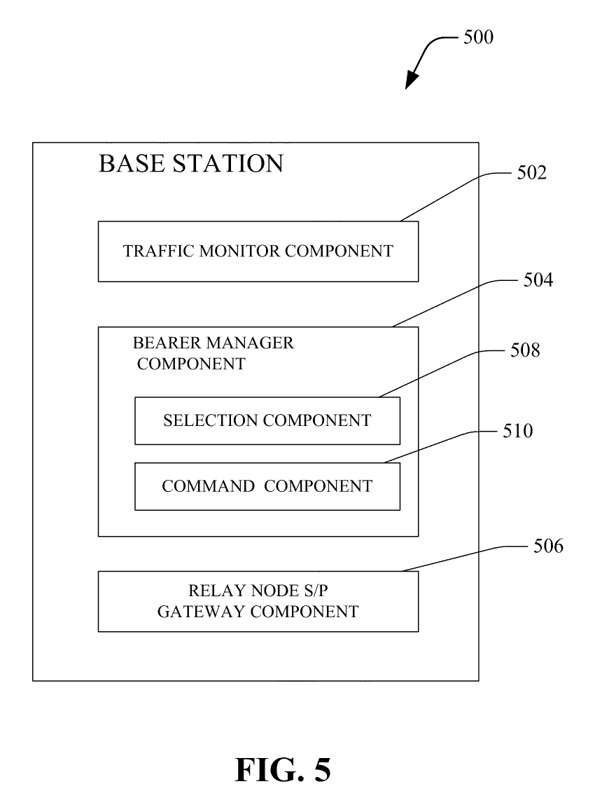

According to certain aspects of the present disclosure, the transmitter system 210 includes additional components for operating in a wireless communications network having a relay node, as described herein. Specifically, the transmitter system 210 may be configured as a donor base station as shown in FIGS. 4-5. According to certain aspects, the transmitter system 210 may be configured to perform traffic monitoring and Uu bearer management operations as described below.

According to certain aspects, logical channels are classified into Control Channels and Traffic Channels. Logical Control Channels comprises Broadcast Control Channel (BCCH) which is DL channel for broadcasting system control information. Paging Control Channel (PCCH) which is DL channel that transfers paging information. Multicast Control Channel (MCCH) which is Point-to-multipoint DL channel used for transmitting Multimedia Broadcast and Multicast Service (MBMS) scheduling and control information for one or several MTCHs. Generally, after establishing RRC connection this channel is only used by UEs that receive MBMS (Note: old MCCH+MSCH). Dedicated Control Channel (DCCH) is Point-to-point bi-directional channel that transmits dedicated control information and used by UEs having an RRC connection. In an aspect, Logical Traffic Channels comprises a Dedicated Traffic Channel (DTCH) which is a Point-to-point bi-directional channel, dedicated to one UE, for the transfer of user information. Also, a Multicast Traffic Channel (MTCH) is a Point-to-multipoint DL channel for transmitting traffic data.

According to certain aspects, Transport Channels are classified into DL and UL. DL Transport Channels comprises a Broadcast Channel (BCH), Downlink Shared Data Channel (DL-SDCH) and a Paging Channel (PCH), the PCH for support of UE power saving (DRX cycle is indicated by the network to the UE), broadcasted over entire cell and mapped to PHY resources which can be used for other control/traffic channels. The UL Transport Channels comprises a Random Access Channel (RACH), a Request Channel (REQCH), an Uplink Shared Data Channel (UL-SDCH) and plurality of PHY channels. The PHY channels comprise a set of DL channels and UL channels.

The DL PHY channels comprises:

Common Pilot Channel (CPICH)

Synchronization Channel (SCH)

Common Control Channel (CCCH)

Shared DL Control Channel (SDCCH)

Multicast Control Channel (MCCH)

Shared UL Assignment Channel (SUACH)

Acknowledgement Channel (ACKCH)

DL Physical Shared Data Channel (DL-PSDCH)

UL Power Control Channel (UPCCH)

Paging Indicator Channel (PICH)

Load Indicator Channel (LICH)

The UL PHY Channels comprises:

Physical Random Access Channel (PRACH)

Channel Quality Indicator Channel (CQICH)

Acknowledgement Channel (ACKCH)

Antenna Subset Indicator Channel (ASICH)

Shared Request Channel (SREQCH)

UL Physical Shared Data Channel (UL-PSDCH)

Broadband Pilot Channel (BPICH)

For the purposes of the present document, the following abbreviations apply:

ACK Acknowledgement

AM Acknowledged Mode

AMD Acknowledged Mode Data

ARQ Automatic Repeat Request

BCCH Broadcast Control CHannel

BCH Broadcast CHannel

BW Bandwidth

C- Control-

CB Contention-Based

CCE Control Channel Element

CCCH Common Control CHannel

CCH Control CHannel

CCTrCH Coded Composite Transport Channel

CDM Code Division Multiplexing

CF Contention-Free

CP Cyclic Prefix

CQI Channel Quality Indicator

CRC Cyclic Redundancy Check

CRS Common Reference Signal

CTCH Common Traffic CHannel

DCCH Dedicated Control CHannel

DCH Dedicated CHannel

DCI Downlink Control Information

DL DownLink

DRS Dedicated Reference Signal

DSCH Downlink Shared Channel

DSP Digital Signal Processor

DTCH Dedicated Traffic CHannel

E-CID Enhanced Cell IDentification

EPS Evolved Packet System

FACH Forward link Access CHannel

FDD Frequency Division Duplex

FDM Frequency Division Multiplexing

FSTD Frequency Switched Transmit Diversity

HARQ Hybrid Automatic Repeat/request

HW Hardware

IC Interference Cancellation

L1 Layer 1 (physical layer)

L2 Layer 2 (data link layer)

L3 Layer 3 (network layer)

LI Length Indicator

LLR Log-Likelihood Ratio

LSB Least Significant Bit

MAC Medium Access Control

MBMS Multimedia Broadcast Multicast Service

MCCH MBMS point-to-multipoint Control Channel

MMSE Minimum Mean Squared Error

MRW Move Receiving Window

MSB Most Significant Bit

MSCH MBMS point-to-multipoint Scheduling CHannel

MTCH MBMS point-to-multipoint Traffic CHannel

NACK Non-Acknowledgement

PA Power Amplifier

PBCH Physical Broadcast CHannel

PCCH Paging Control CHannel

PCH Paging CHannel

PCI Physical Cell Identifier

PDCCH Physical Downlink Control CHannel

PDU Protocol Data Unit

PHICH Physical HARQ Indicator CHannel

PHY PHYsical layer

PhyCH Physical CHannels

PMI Precoding Matrix Indicator

PRACH Physical Random Access Channel

PSS Primary Synchronization Signal

PUCCH Physical Uplink Control CHannel

PUSCH Physical Uplink Shared CHannel

QoS Quality of Service

RACH Random Access CHannel

RB Resource Block

RLC Radio Link Control

RRC Radio Resource Control

RE Resource Element

RI Rank Indicator

RNTI Radio Network Temporary Identifier

RS Reference Signal

RTT Round Trip Time

Rx Receive

SAP Service Access Point

SDU Service Data Unit

SFBC Space Frequency Block Code

SHCCH SHared channel Control CHannel

SINR Signal-to-Interference-and-Noise Ratio

SN Sequence Number

SR Scheduling Request

SRS Sounding Reference Signal

SSS Secondary Synchronization Signal

SU-MIMO Single User Multiple Input Multiple Output

SUFI SUper Field

SW Software

TA Timing Advance

TCH Traffic CHannel

TDD Time Division Duplex

TDM Time Division Multiplexing

TFI Transport Format Indicator

TPC Transmit Power Control

TTI Transmission Time Interval

Tx Transmit

U- User-

UE User Equipment

UL UpLink

UM Unacknowledged Mode

UMD Unacknowledged Mode Data

UMTS Universal Mobile Telecommunications System

UTRA UMTS Terrestrial Radio Access

UTRAN UMTS Terrestrial Radio Access Network

VOIP Voice Over Internet Protocol

MBSFN multicast broadcast single frequency network

MCH multicast channel

DL-SCH downlink shared channel

PDCCH physical downlink control channel

PDSCH physical downlink shared channel

### An Example Relay System

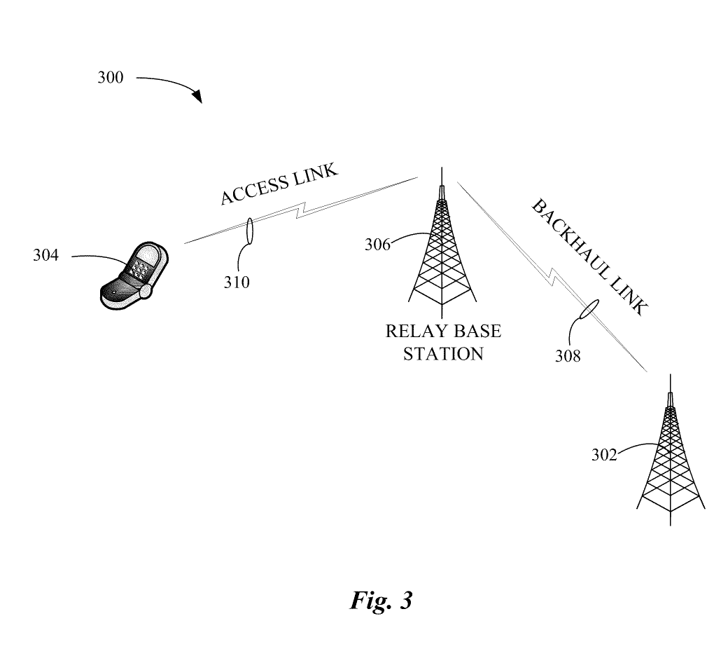

FIG. 3 illustrates an example wireless system 300 in which certain aspects of the present disclosure may be practiced. As illustrated, the system 300 includes a donor base station (also known as a donor access point, a donor base station, a donor eNodeB, or DeNB) 302 that communicates with a user equipment (UE) 304 via a relay BS (also known as relay access point or relay node) 306. The relay BS 306 may communicate with the donor BS 302 via a backhaul link 308 and with the UE 304 via an access link 310.

In other words, the relay BS 306 may receive downlink messages from the donor BS 302 over the backhaul link 308 and relay these messages to the UE 304 over the access link 310. Similarly, the relay BS 306 may receive uplink messages from the UE 304 over the access link 310 and relay these messages to the donor BS 302 over the backhaul link 308. The relay BS 306 may, thus, be used to supplement a coverage area and help fill “coverage holes.”

According to certain aspects, the relay BS 306 may communicate with the UE 304 (i.e., relay downlink messages to the UE and receive uplink messages from the UE) utilizing at least one Uu radio bearer configured for the access link 310. According to certain aspects, the relay BS 306 may communicate with the donor BS 302 utilizing at least one Un radio bearer configured for the backhaul link 308.

FIG. 4 illustrates a block diagram of an example system 400 that is configured to perform techniques for managing and mapping radio bearers according to certain aspects of the present disclosure. Example system 400 represents a wireless telecommunication network having a plurality of UEs 410, a relay node 420, base stations 430, 435, and a network node 440.

The base station 430 operates as the donor base station of relay node 420. As such, the relay node 420 may serve multiple UEs 410 by relaying wireless communications between the UEs 410 and the base station 430. The base station 430 provides communication between the plurality of UEs 410 and the at least one network node 440. The network nodes 440 are configured to manage network services for the UEs 410. According to certain aspects, the network nodes 440 may be an Evolved Packet Core (EPC) network node, such as a mobility management entity (MME), Packet Data Network (PDN) gateway (P-GW), or serving gateway (S-GW). According to certain aspects, an S1 interface connects the base station 430 and the network node 440. Generally, the network node 440 controls bearer and connection management through control plane signals transmitted across the S1 interface. Additionally, the base station 430 may be inter-connected to base station 435 to share load, interference, or handover related information.

According to certain aspects, multiple Uu radio bearers are utilized to carry data packet flow between the relay node 420 and the UEs 410. Similarly, multiple Un radio bearers are utilized to carry flow between the relay node 420 and the base station 430, and multiple Uu EPS bearers are utilized to route traffic from the network nodes 440 to the UEs 410. The Uu radio bearers of the UEs 410 are carried by the Un bearers of the relay node 420. As discussed above, the base station 430 may have visibility of both Un and Uu bearers, and the base station 430 may also operate on both Un and Uu bearers in certain aspects of queue management and bearer mapping. However, in traditional configurations, the base station 430 cannot directly initiate control plane transactions for the Uu bearers carried by their Un bearers. However, when the Un interface is congested, the base station 430 may thus need to release some Uu bearers, or even UE contexts, that are carried by the Un bearers. According to certain aspects, when the Un interface is congested, the base station 430 is configured to perform actions that result in removal of at least one Uu bearer carried by the Un interface, as further described below. According to certain aspects, the UEs 410, relay node 420, base station 430, 435, and network nodes 440 are configured to coordinate Uu bearer management, according to mechanisms for facilitating removal of Uu bearers described herein.

FIG. 5 illustrates a donor base station 500 for wireless communications according to certain aspects of the present disclosure. While certain aspects of the disclosure are discussed in regards to the donor base station 500, it is understood that other suitable communications apparatuses are contemplated, such as base stations of macrocell, femtocell, picocell, an access point, a relay node, a mobile base station, a portion thereof, and/or substantially any wireless device that transmits signals to one or more disparate devices in a wireless network. According to certain aspects, the donor base station 500 may be the donor base station 430 as described in FIG. 4.

According to certain aspects, the donor base station 500 generally includes a traffic monitor component 502, a bearer manager component 504, and a relay node Serving and PDN Gateway (S/P-GW) component 506. The traffic monitor component 502 is configured to monitor traffic across interfaces connected to the donor base station 500 and to detect a state of traffic congestion on a given interface. According to certain aspects, the traffic monitor component 502 may determine traffic congestion on a Un interface configured to interface between the donor base station 500 and a relay node. According to certain aspects, the relay node S/P-GW component 506 is configured to provide S-GW- and P-GW-like functionality for a connected relay node, such as session establishment and EPS bearer management for the relay node.

Generally, the bearer manager component 504 is configured to perform the bearer management operations described herein. For example, the bearer manager component 504 may manage a Un interface between the donor base station 500 and a connected relay node for carrying Uu bearers and other data flows. The bearer manager component 504 may also establish an S1 interface between the donor base station 500 and a network node, such as a mobility management entity, for signaling and network coordination.

According to certain aspects, the bearer manager component 504 includes a selection component 508 and a command component 510. The selection component 508 may be configured to select at least one of a plurality of Uu radio bearers to deactivate from the Un interface of the donor base station 500 in order to alleviate traffic congestion on the Un interface. According to certain aspects, the selection component 508 may determine a Uu radio bearer to be deactivated based on the Allocation and Retention Priority (ARP) of the Uu bearers.

The command component 510 is configured to generate a signal to a network node, such as a mobility management entity, that results in removal of at least one of the Uu bearers on the Un interface. According to certain aspects, the command component 510 may generate a UPDATE BEARER REQUEST command to modify a QoS of the Un interface that results in removal of at least one Uu bearers on the Un interface. According to certain aspects, the command component 510 may generate an INDICATION OF BEARER RELEASE command to directly deactivate at least one Uu bearer carried on the donor base station 500's Un interface. According to certain aspects, the command component may generate a wireless terminal CONTEXT RELEASE REQUEST command to request release of a UE context stored by the donor base station 500 and connected network nodes.

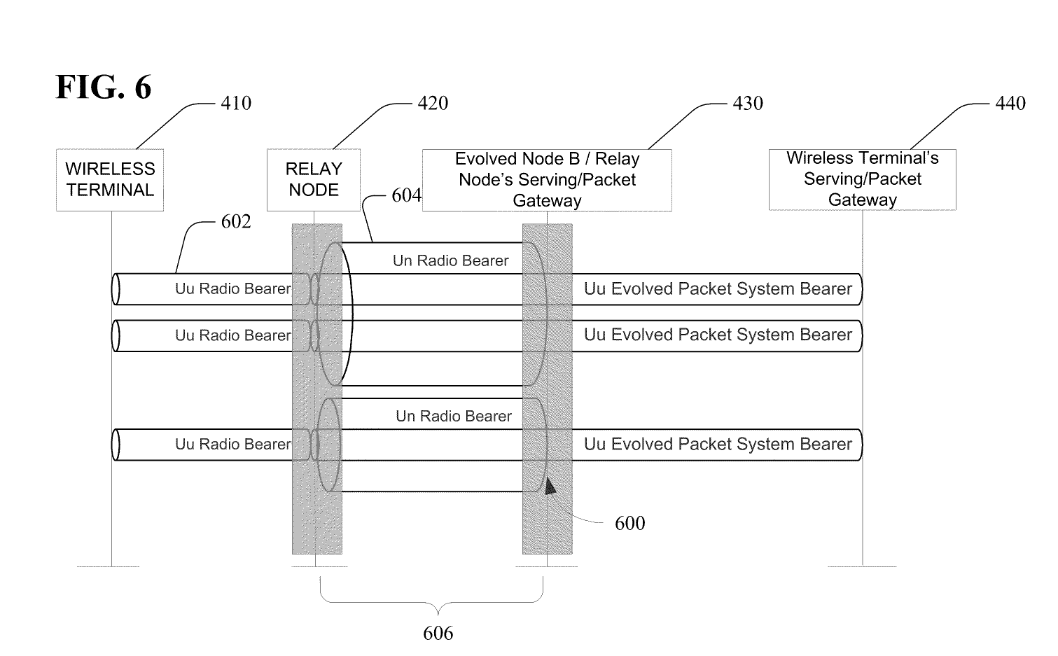

FIG. 6 illustrates an example of mapping 600 between Uu radio bearers 602 and Un radio bearers 604 in the example wireless communication system 400, described above, according to certain aspects of the disclosure. A plurality of Uu radio bearers 602 provide data flow between a wireless terminal 410 and the relay node 420. The plurality of Uu radio bearers 602 are mapped to a single Un radio bearer 604 in the interface 606 between the relay node 420 and donor base station 430. The mapped Uu radio bearers 602 represent data packet flow from the wireless terminals 410 to the wireless terminal's S/P-GW 440 on Uu Evolved Packet System (EPS) bearers. According to certain aspects, the donor base station 430 may be the donor base station 500 shown in FIG. 5.

As discussed above, certain aspects of the disclosure provide mechanisms for managing the Uu bearers carried on the Un interface 606 when traffic congestion is detected on the Un interface 606. According to certain aspects, the donor base station 430 may be configured to take one or more actions to initiate removal of at least one of the Uu radio bearers 602 mapped to the Un radio bearer 604 from the Un interface 606.

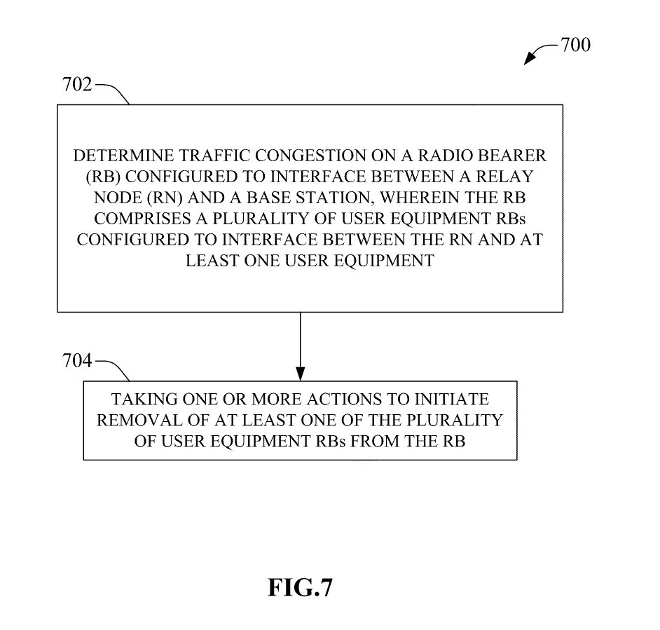

FIG. 7 illustrates example operations 700 for operating a donor base station according to certain aspects of the present disclosure. According to certain aspects, the example operations 700 may be performed by a donor base station having a first plurality of radio bearers that interface with a relay node. For example, the donor base station 500 shown in FIG. 5 may be configured to perform the operations 700. It is contemplated that other suitable components and apparatuses configured according to certain aspects of the present disclosure may be utilized to perform the example operations 700.

The operations 700 begin, at 702, by determining traffic congestion on the first plurality of radio bearers. According to certain aspects, the donor base station may monitor traffic on the first plurality of radio bearers to detect congestion on at least one of the first plurality of radio bearers.

At 704, responsive to detecting traffic congestion, the donor base station takes one or more actions to trigger removal of at least one of a second plurality of radio bearers that interface between the relay node and at least one UE. It is understood that the one or more actions taken may directly or indirectly cause the removal of at least one of the second plurality of radio bearers through any number of intermediate steps, procedures, processes, or chains of events. For example, in an LTE network having multiple network components that coordinate to support wireless communications, the one or more actions taken by a donor base station may trigger subsequent messaging between the network components responsive to the one or more actions. According to certain aspects, the one or more actions taken by the donor base station may include operations for indirect Uu bearer deactivation by a donor base station, operations for direct Uu bearer deactivation by a donor base station, and operations for UE context release by a donor base station, as described further below. As noted, it is understood that operations performed by the donor base station, described below, may trigger any number of subsequent requests, responses, reconfigurations, acknowledgments, indications, commands, and signaling among network components that results in Uu bearer removal.

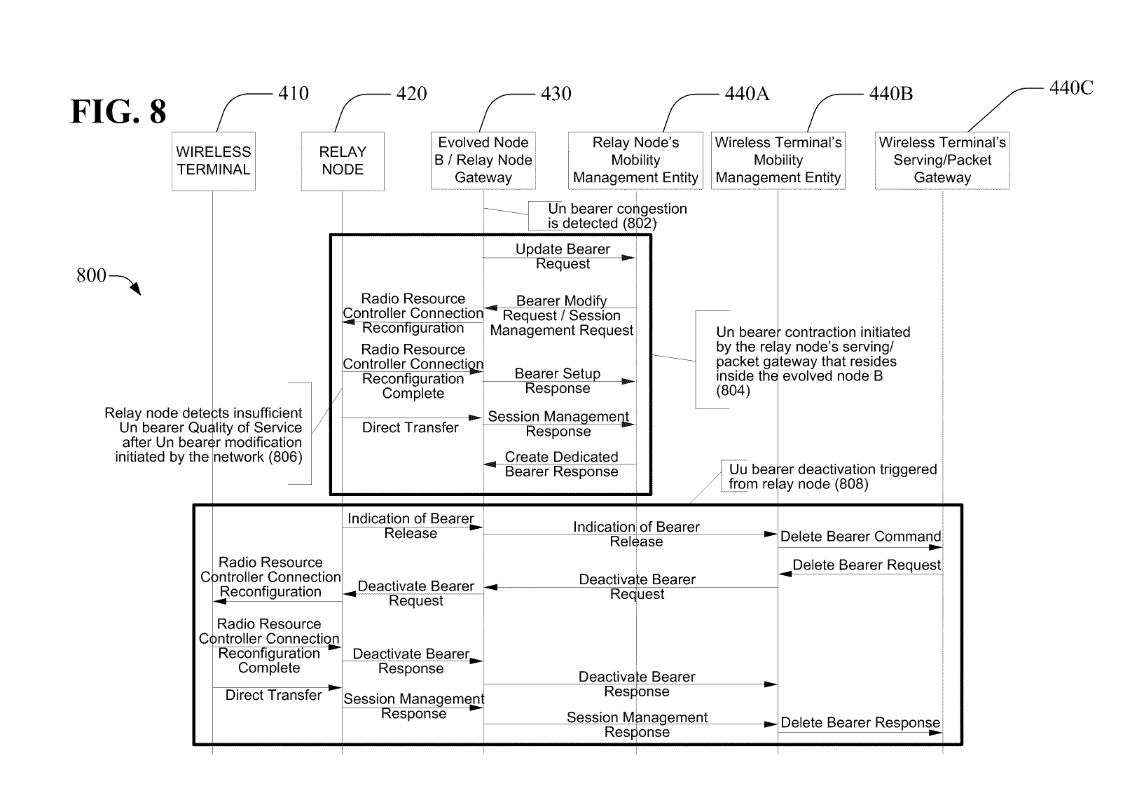

FIG. 8 is a sequence diagram illustrating operations for an indirect Uu bearer deactivation mechanism according to certain aspects of the disclosure. For clarity, the operations are depicted as being performed by the example system 400 shown in FIG. 4, but it is understood that the example operations may be performed by any suitable apparatus and components according to aspects of the disclosure.

At 802, the donor base station detects traffic congestion on a Un bearer. At 804, the donor base station initiates Un bearer contraction by modifying the QoS of the congested Un bearer. Generally, the QoS of a bearer may be defined by a number of parameters. According to certain aspects, the QoS parameters include a QoS Class Identifier (QCI), which is a scalar that is utilized as a reference to bearer level packet forwarding treatment (e.g. scheduling weights, admission thresholds, queue management thresholds, link layer protocol configuration, etc.); an Allocation and Retention Priority (ARP), which is used to decide whether a bearer establishment or modification request can be accepted or needs to be rejected in cases of resource limitations; a Guaranteed Bit Rate (GBR), which denotes the bit rate that can be expected to be provided by a GBR radio bearer; and a Maximum Bit Rate (MBR) which indicates a limit to the bit rate that can be expected to be provided by a GBR radio bearer. According to certain aspects, the donor base station may modify at least one of the QoS parameters of the congested Un bearer to reduce the QoS indicated therein. As an example, the donor base station may reduce the GBR of the Un bearer from 10 Mbps to 8 Mbps.

According to certain aspects, as shown in FIG. 8, the relay node Serving/Packet gateway component within the donor base station may initiate Un bearer contraction by generating an “Update Bearer Request” to the relay node's MME. As shown, the relay node's MME may respond with a bearer modify request and a session management request to control the Un bearer configuration of the system.

As a result, at 806, the relay node subsequently finds out that the updated QoS of the Un bearer may not support the Uu bearers carried by this Un bearer. According to certain aspects, the relay node detects insufficient Un bearer QoS after Un bearer modification was initiated by the network. As shown, the relay node receives a radio resource controller connection reconfiguration message from the donor base station indicating the modified QoS.

At 808, responsive to the modified QoS, the relay node triggers Uu bearer deactivation. According to certain aspects, the relay node selects at least one of the plurality of Uu bearers to deactivate from the corresponding Un bearer based on the modified QoS. According to certain aspects, the relay node examines the ARP of each of the Uu bearers carried by the congested Un bearer to determine which Uu bearer to deactivate.

According to certain aspects, the relay node may then generate an indication to an MME associated with the UE corresponding to the selected Uu bearer of the bearer release of the selected Uu bearer. As shown, the relay node transmits an indication of bearer release to the wireless terminal's MME via the donor base station. Subsequently, the wireless terminal's MME coordinates a deactivation bearer request with the wireless terminal's Serving/Packet Gateway and donor base station to deactivate the selected Uu bearer from the congested Un bearer.

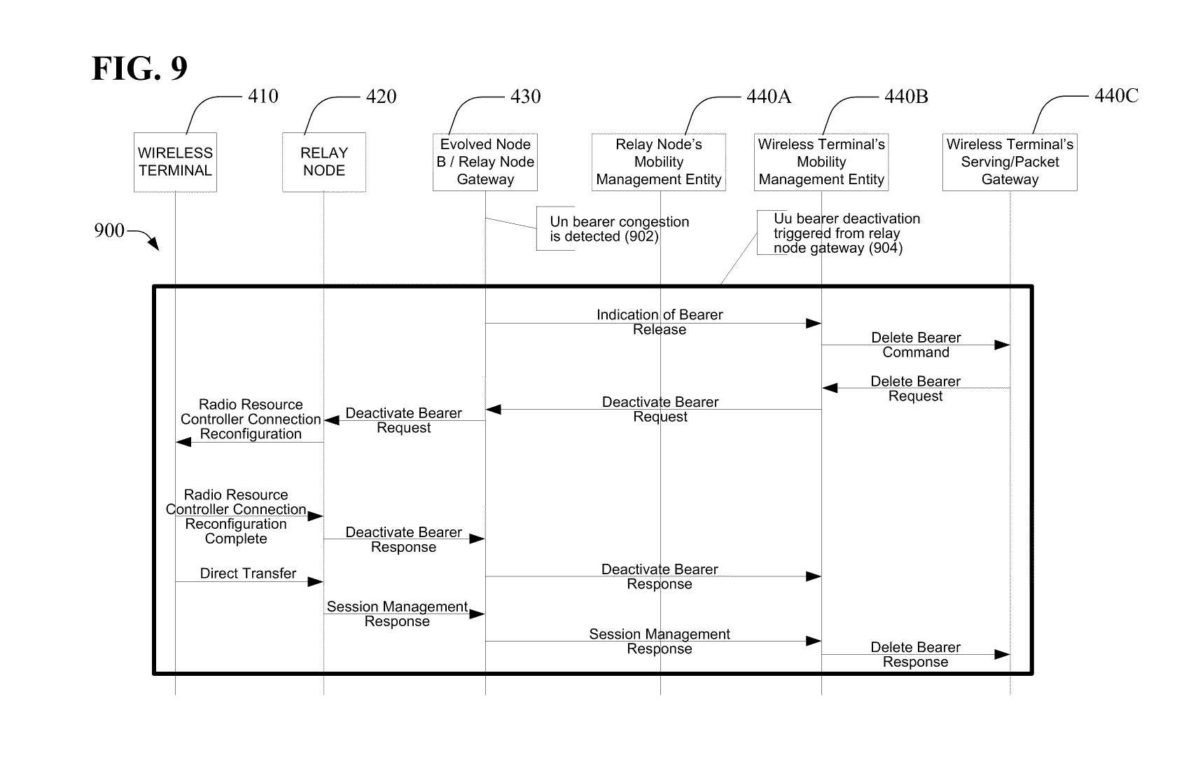

FIG. 9 is a sequence diagram illustrating example operations for direct Uu bearer deactivation mechanism according to certain aspects of the disclosure. The example operations begin at 902, when traffic congestion on a Un bearer is detected at the donor base station. At 904, Uu bearer deactivation is directly triggered by the relay node gateway component of the donor base station. The donor base station selects at least one of the plurality of Uu bearers to deactivate from the corresponding Un bearer based on the traffic congestion. According to certain aspects, the donor base station may examine the ARP of the Uu bearers to determine which Uu bearer it will deactivate.

Subsequently, the relay node gateway component of the donor base station generates an indication to the UE's MME associated with the UE corresponding to the selected Uu bearer of bearer release of the selected Uu bearer. As depicted in FIG. 9, relay node S/P gateway transmits an Indication of Bearer Release to the UE's MME (illustrated as 440B) so that the UE's MME can initiate a Uu bearer deactivation procedure. For example, after receiving the Indication of Bearer Release from the relay node gateway, the UE's MME communicates a Delete Bearer Command to the UE's S/P Gateway (illustrated as 440C) which responds with a Delete Bearer Request that is propagated to the relay node as a Deactivate Bearer Request.

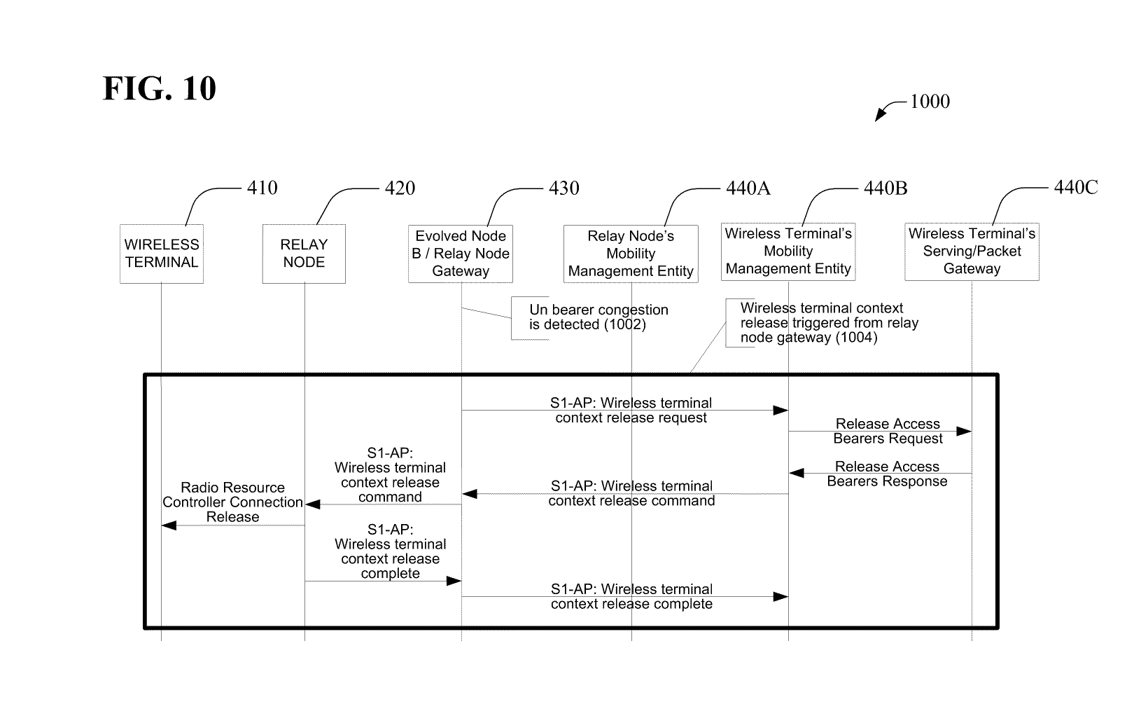

FIG. 10 is a sequence diagram illustrating example operations for a user equipment context release mechanism according to certain aspects of the disclosure. The operations begin, at 1002, when Un bearer congestion is detected at the donor base station. At 1004, UE context release is triggered by the relay node gateway component incorporated within the donor base station. The donor base station selects one of the plurality of UEs to release from communications based on the traffic congestion. According to certain aspects, the donor base station examines the ARP of the Uu bearers carried by the Un bearer to determine which Uu bearer to deactivate.

However, in this case, instead of only deactivating the selected Uu bearer, the donor base station triggers the UE context release for the UE corresponding to the selected Uu bearer, which may affect multiple additional bearers associated with the same UE. It is further noted that implementation of example operations may also release S1 application protocol interface messages and all S1-U bearers of the associated UE. According to certain aspects, the relay node gateway component incorporated within the donor base station generates an indication to the selected UE's MME (illustrated as 440B) to request context release of the selected UE. As shown in FIG. 10, the relay node gateway component triggers UE context release by transmitting a UE context release request to the UE's MME 440B via the S1-AP interface so that the UE's MME may initiate a UE context release procedure.

It is understood that the specific order or hierarchy of steps in the processes disclosed is an example of exemplary approaches. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the embodiments disclosed herein may be implemented or performed with a general purpose processor, a digital signal processor (DSP), an ASIC, a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

What is claimed is:

1. A method for operating a donor base station having a first plurality of radio bearers (RBs) that interface with a relay node, the method comprising:
determining traffic congestion on the first plurality of RBs; and
taking one or more actions to trigger removal of at least one of a second plurality of RBs that interface between the relay node and at least one user equipment (UE).

2. The method of claim 1, wherein taking one or more actions comprises:
selecting at least one of the second plurality of RBs based on an indication of an allocation and retention priority (ARP) of each of second plurality of RBs; and
generating an indication to a mobility management entity (MME) to trigger removal of the selected RB.

3. The method of claim 1, wherein taking one or more actions comprises:
modifying a quality of service (QoS) associated with the first plurality of RBs based on the traffic congestion.

4. The method of claim 3, wherein the QoS is modified such that the relay node, responsive to the modified QoS, selects at least one of the second plurality of RBs for removal, and generates an indication of bearer release of the selected RB for a mobility management entity (MME) associated with a UE associated with the selected RB.

5. The method of claim 1, wherein the taking one or more actions comprises:
selecting at least one of the second plurality of RBs to deactivate based on the traffic congestion; and
generating an indication, to a mobility management entity (MME) associated with a UE associated with the selected RB, of bearer release of the selected RB.

6. The method of claim 1, wherein the taking one or more actions comprise:
selecting at least one of the second plurality of RBs to deactivate based on the traffic congestion; and
generating an indication, to a mobility management entity (MME), to request UE context release of a UE associated with the selected RB.

7. A donor base station having a first plurality of radio bearers (RBs) that interface with a relay node, the donor base station comprising:
a traffic monitor component configured to determine traffic congestion on the first plurality of RBs; and
a radio bearer manager component configured to take one or more actions to trigger removal of at least one of a second plurality of RBs that interface between the relay node and at least one user equipment (UE).

8. The donor base station of claim 7, wherein the radio bearer manager component is further configured to:
select at least one of the second plurality of RBs based on an indication of an allocation and retention priority (ARP) of each of second plurality of RBs; and
generate an indication to a mobility management entity (MME) to trigger removal of the selected RB.

9. The donor base station of claim 7, further comprising:
a gateway component configured to modify a quality of service (QoS) associated with the first plurality of RBs based on the traffic congestion.

10. The donor base station of claim 9, wherein the gateway component is configured to modify the QoS such that the relay node, responsive to the modified QoS, selects at least one of the second plurality of RBs for removal, and generates an indication of bearer release of the selected RB for a mobility management entity (MME) associated with a UE associated with the selected RB.

11. The donor base station of claim 7, wherein the radio bearer manager component is further configured to:
select at least one of the second plurality of RBs to deactivate based on the traffic congestion; and
generate an indication, to a mobility management entity (MME) associated with a UE associated with the selected RB, of bearer release of the selected RB.

12. The donor base station of claim 7, wherein the radio bearer manager component is further configured to:
select at least one of the second plurality of RBs to deactivate based on the traffic congestion; and
generate an indication, to a mobility management entity (MME), to request UE context release of a UE associated with the selected RB.

13. An apparatus for wireless communications having a first plurality of radio bearers (RBs) that interface with a relay node, comprising:
means for determining traffic congestion on the first plurality of RBs; and
means for taking one or more actions to trigger removal of at least one of a second plurality of RBs that interface between the relay node and at least one user equipment (UE).

14. The apparatus of claim 13, wherein the means for taking one or more actions comprises:
means for selecting at least one of the second plurality of RBs based on an indication of an allocation and retention priority (ARP) of each of second plurality of RBs; and
means for generating an indication to a mobility management entity (MME) to trigger removal of the selected RB.

15. The apparatus of claim 13, wherein the means for taking one or more actions comprises:
means for modifying a quality of service (QoS) associated with the first plurality of RBs based on the traffic congestion.

16. The apparatus of claim 15, wherein the QoS is modified such that the relay node, responsive to the modified QoS, selects at least one of the second plurality of RBs for removal, and generates an indication of bearer release of the selected RB for a mobility management entity (MME) associated with a UE associated with the selected RB.

17. The apparatus of claim 13, wherein the means for taking one or more actions comprises:
means for selecting at least one of the second plurality of RBs to deactivate based on the traffic congestion; and
means for generating an indication, to a mobility management entity (MME) associated with a UE associated with the selected RB, of bearer release of the selected RB.

18. The apparatus of claim 13, wherein the means for taking one or more actions comprise:
means for selecting at least one of the second plurality of RBs to deactivate based on the traffic congestion; and
means for generating an indication, to a mobility management entity (MME), to request UE context release of a UE associated with the selected RB.

19. A computer program product comprising a computer readable medium having instructions for operating a donor base station having a first plurality of radio bearers (RBs) that interface with a relay node stored thereon, the instructions executable by one or more processors for:
determining traffic congestion on the first plurality of RBs; and
taking one or more actions to trigger removal of at least one of a second plurality of RBs that interface between the relay node and at least one user equipment (UE).

20. The computer program product of claim 19, wherein the instructions for taking one or more actions comprises instructions for:
selecting at least one of the second plurality of RBs based on an indication of an allocation and retention priority (ARP) of each of second plurality of RBs; and
generating an indication to a mobility management entity (MME) to trigger removal of the selected RB.

21. The computer program product of claim 19, wherein the instructions for taking one or more actions comprises instructions for:
modifying a quality of service (QoS) associated with the first plurality of RBs based on the traffic congestion.

22. The computer program product of claim 21, wherein the QoS is modified such that the relay node, responsive to the modified QoS, selects at least one of the second plurality of RBs for removal, and generates an indication of bearer release of the selected RB for a mobility management entity (MME) associated with a UE associated with the selected RB.

23. The computer program product of claim 19, wherein the instructions for taking one or more actions comprises instructions for:
selecting at least one of the second plurality of RBs to deactivate based on the traffic congestion; and
generating an indication, to a mobility management entity (MME) associated with a UE associated with the selected RB, of bearer release of the selected RB.

24. The computer program product of claim 19, wherein the instructions for taking one or more actions comprises instructions for:
selecting at least one of the second plurality of RBs to deactivate based on the traffic congestion; and
generating an indication, to a mobility management entity (MME), to request UE context release of a UE associated with the selected RB.
